(19) United States
(12) Patent Application Publication
(10) Pub. No.: US 2023/0250579 A1
(43) Pub. Date: Aug. 10, 2023

(54) THERMOPLASTIC COPOLYAMIDES FOR ASSEMBLY OF TEXTILES

(71) Applicants: ARKEMA FRANCE, Colombes (FR); BOSTIK SA, Colombes (FR)

(72) Inventors: Thomas PRENVEILLE, SERQUIGNY (FR); Quentin PINEAU, Serquigny (FR); Sophie CHHUN, SINGAPORE (SG)

(73) Assignees: ARKEMA FRANCE, Colombes (FR); BOSTIK SA, Colombes (FR)

(21) Appl. No.: 18/006,080

(22) PCT Filed: Jul. 23, 2021
(86) PCT No.: PCT/FR2021/051378

§ 371 Date: Jan. 19, 2023

(30) Foreign Application Priority Data
Jul. 23, 2020 (FR) FR2007741

(51) Int. Cl. D06M 15/592; D06M 17/08

(52) U.S. Cl. CPC D06M 15/592; D06M 17/08; D06M 2101/34

(57) ABSTRACT

The use, for seamless textile assembly by printing, of a copolyamide including: a) at least one hard segment obtained by polycondensation of at least one of the following: (i) an α,ω-aminocarboxylic acid; (ii) a lactam; and/or (iii) an aliphatic diacid with 6 to 22 carbon atoms and at least one aliphatic diamine with 2 to 14 carbon atoms, and, optionally, b) at least one soft segment obtained by polycondensation of at least one diacid with 4 to 44 carbon atoms with at least one diamine chosen from diamines with 2 to 44 carbon atoms and polyoxyalkylene diamines, the copolyamide having a melting temperature Tm above 80° C. and below 210° C. and a viscosity at 170° C., as measured according to standard ASTM D3236-88 (2009), using a Brookfield rheometer with SC 4-27 spindle, of between 5 Pa·s and 100-200 Pa·s.

### TECHNICAL FIELD

The present patent application relates to the use of copolyamides for seamless textile assembly by printing, to an associated seamless textile assembly process and to articles thus obtained.

### PRIOR ART

For reasons in particular of comfort, it may be desirable to assemble seamless textiles. Thus, seamless bonding of textiles is a popular technology for the manufacture of close-fitting garments such as underwear and sportswear.

Such textile assemblies can be produced by means of hot-melt adhesives which, pre-melted, make it possible to assemble various substrates by bonding during cooling. The adhesive can be applied by spraying, using adhesive tapes or sewn-in adhesive filaments, or else by printing.

Printing is a particularly advantageous process insofar as it allows a precise and controlled deposition, an adjustment of the amount of adhesive necessary and it is compatible with the automation of production.

A technique for printing by spraying droplets onto the substrate (“jetting”) is thus known from application WO 2011/153422 A1. However this technique uses hot melt polyurethane reactive (HMPUR) adhesives, which have certain drawbacks. Specifically, firstly, they are reactive adhesives which have a limited open time after activation. Secondly, their residual content of free isocyanate monomers, considered toxic, reprotoxic, sensitizing, carcinogenic and causing skin allergies, raises reservations in terms of HSE and regulatory labeling. Furthermore, these adhesives are crosslinkable and therefore infusible after use, which makes them difficult to recycle.

### SUMMARY OF THE INVENTION

The objective of the invention is therefore to provide hot-melt adhesives useful for seamless textile assembly by printing which do not have some of these drawbacks.

According to one aspect of the invention, such hot-melt adhesives are sought which allow greater flexibility when they are used in the printing assembly process in that they do not have an open time. According to another aspect of the invention, such hot-melt adhesives are sought which are more friendly to health and the environment.

Finally, according to another aspect of the invention, such hot-melt adhesives are sought which allow the recycling of the textiles assembled therewith.

In order to be suitable for seamless textile assembly by printing, the hot-melt adhesives must meet strict specifications. Thus, they must exhibit good adhesion to the textile substrate, and have a melting point high enough to allow washing at 40° C. but low enough to allow bonding at a temperature which the textile substrate withstands. Furthermore, they preferably have sufficient thermal resistance to withstand thermal stresses during printing and the subsequent assembly and advantageously good resistance to steam and solvents in order to allow steam cleaning and dry cleaning.

Preferably, these hot-melt adhesives have properties compatible with the application thereof by printing. Such modes of application are for example the “jetting” process, in which droplets of hot-melt adhesive in the melt state are deposited by spraying onto the substrate, therefore without direct contact between the print head and the substrate. It is also possible to deposit the hot-melt adhesive by means of additive manufacturing equipment, for example by fused filament deposition (FDM/FFF), or by deposition of extruded droplets. In these techniques, the print head is generally in contact with the substrate during the deposition.

In particular, the hot-melt adhesives should have a viscosity suitable for the chosen mode of application. More specifically, the viscosity of the hot-melt adhesive must be low enough to be able to pass easily through the print head and high enough to prevent it from penetrating and diffusing into the textile.

The present invention is based on the observation that copolyamides comprising hard segments and, where appropriate, soft segments as defined below are particularly suitable for use for seamless textile assembly by printing.

The use of copolyamides furthermore avoids the HSE risks associated with reactive thermoplastic polyurethanes, in particular the presence of residual isocyanate monomers, and therefore has a more favorable HSE profile.

Finally, owing to the thermoplastic nature of copolyamides, the articles thus produced can be recycled more easily. In particular, when the textiles comprise or do themselves consist of polyamide, the complete article can be ground and melted to form a mass capable of being used again.

Therefore, according to a first aspect, the invention relates to the use, for seamless textile assembly by printing, of a copolyamide comprising:
a) at least one hard segment obtained by polycondensation of at least one of the following:
   (i) an α,ω-aminocarboxylic acid;
   (ii) a lactam; and
   (iii) an aliphatic diacid with 6 to 22 carbon atoms and an aliphatic diamine with 2 to 14 carbon atoms, and, optionally,
b) at least one soft segment obtained by polycondensation of at least one diacid with 4 to 44 carbon atoms with at least one diamine chosen from diamines with 2 to 44 carbon atoms and polyoxyalkylene diamines,
   said copolyamide having a melting temperature (Tm) above 80° C. and a viscosity at 170° C., as measured according to standard ASTM D3236-88 (2009), using a Brookfield rheometer with SC 4-27 spindle, of between 2 Pa·s and 200 Pa·s and preferably between 5 Pa·s and 100 Pa·s.

According to a particular embodiment, the copolyamide comprises hard segments obtained by polycondensation of caprolactam, 11-aminoundecanoic acid, 1,6-hexamethylenediamine and sebacic acid, 1,10-decamethylenediamine and sebacic acid, or 1,10-decamethylenediamine and 1,12-dodecanedioic acid, or a mixture thereof.

According to another particular embodiment, the copolyamide comprises hard segments obtained by polycondensation of caprolactam, 1,6-hexamethylenediamine and adipic acid, or a mixture thereof. According to another particular embodiment, the copolyamide comprises soft segments obtained by polycondensation of a polyoxyalkylene diamine having a molecular weight of between 60 and 2000 g/mol and of an aliphatic diacid comprising 6 to 36 carbon atoms.

According to yet another particular embodiment, the copolyamide is chosen from the group consisting of PA 6/11/POP40036, PA 6/11/POP4006, PA 11/POP4006, PA 11/POP40010, PA 6/12/POP40036, PA 6/12/POP4006, PA 12/POP4006 and PA 12/POP40010, PA 6/66/11/12/POP4006, PA 6/612/12/POP40012, PA 6/66/11/12/POP4006, PA 6/11/3636 and PA 11/3636.

According to another particular embodiment, the copolyamide is chosen from PA 6/11/12, PA 6/612/12, PA 6/1012/12 and PA 6/66/11/12.

According to another particular embodiment, the copolyamide has a melting temperature (Tm) below 210° C. and/or a glass transition temperature (Tg) below 60° C.

According to another particular embodiment, the copolyamide makes it possible to achieve a peel strength, measured according to the test described in the examples, of at least 8 N/12.5 mm, at 23° C. According to a second aspect, the invention relates to a process for manufacturing articles by seamless assembly by printing, wherein the textile substrates are assembled by means of a copolyamide as defined above.

According to a particular embodiment, the textile substrates comprise a polyamide.

According to a third aspect, the invention relates to an article capable of being obtained by said process. According to a particular embodiment, the article is a garment, in particular an undergarment, such as a bra or underpants, sportswear or safety clothing, or a shoe, in particular a sports shoe. Other features, aspects, subjects and advantages of the present invention will emerge more clearly on reading the description and the examples that follow.

### DESCRIPTION OF THE EMBODIMENTS

### Definition of the Terms

The term “textile” is understood to denote essentially flat and flexible materials, consisting of a network of natural or synthetic fibers. Textiles can be made by many techniques, for example by weaving, knitting, crocheting, knotting, felting or braiding. These can be traditional textiles, such as fabrics used in the field of clothing or furnishings, nonwovens or technical textiles, such as geotextiles, medical textiles, agrotextiles or else composite materials with textile reinforcement.

The term “copolymer” is understood to denote a polymer derived from the copolymerization of at least two chemically different types of monomer, referred to as comonomers, of which at least one, preferably two or three and in particular all the monomers are polyamide monomers as defined below. A comonomer other than the polyamide monomers can in particular be a polyether monomer as defined below. A copolymer is thus formed from at least two different repeating units or moieties. It can also be formed of three or more repeating units. The copolyamide within the meaning of the present invention is preferably a block copolymer, in which each repeating unit forms a segment of a certain length, having a glass transition temperature (Tg) and, where appropriate, a specific melting temperature (Tm). The copolyamide used according to the invention has hard segments and, where appropriate, soft segments.

The term “monomer” as used in the context of the description of the polyamides should be taken in the sense of the monomer necessary to form a repeating unit. Indeed, a special case is the case where the repeating unit of the polyamide is formed by the combination of a diacid with a diamine. It is then considered that it is the diamine/diacid pair (in an equimolar amount) which corresponds to the monomer, since individually the diacid and the diamine are not capable of polymerizing.

The term “viscosity” is understood to denote the apparent viscosity as measured, unless otherwise indicated, at 170° C., with a Brookfield rheometer using the SC 4-27 spindle, according to the ASTM D3236-88 standard of 2009.

The term “melting temperature” is understood to denote the temperature at which an at least partially crystalline polymer changes to the viscous liquid state, as measured by differential scanning calorimetry (DSC) according to the standard NF EN ISO 11 357-3 using a heating rate of 20° C./min.

The term “glass transition temperature” is understood to denote the temperature at which an at least partially amorphous polymer changes from a rubbery state to a glassy state, or vice versa, as measured by differential scanning calorimetry (DSC) according to the standard NF EN ISO 11357-2 using a heating rate of 20° C./min.

The terms “hard segments” and “soft segments” are understood to denote segments formed by the various repeating units of the copolyamide depending on their Tm or Tg, the soft segments having a lower Tm or Tg than the hard segments. Generally, the Tg of the soft segments is below 10° C. while the Tg of the hard segments is above 10° C.

The nomenclature used to define polyamides is described in the standard ISO 1874-1:1992 “Plastics -Polyamide (PA) moulding and extrusion materials - Part 1: Designation”, in particular on page 3 (tables 1 and 2), and is well known to those skilled in the art. In the PAL notation, PA denotes polyamide and L denotes the number of carbon atoms of the amino acid or else of the lactam. Thus, the polyamide is obtained by the polycondensation of the amino acid or of the lactam comprising L carbon atoms. In the PAMN notation, M designates the number of carbon atoms of the diamine and N designates the number of carbon atoms of the diacid.

As mentioned above, the invention relates, according to a first aspect, to the use, for seamless textile assembly by printing, of a copolyamide comprising:
a) at least one hard segment obtained by polycondensation of at least one of the following:
   (i) an α,ω-aminocarboxylic acid;
   (ii) a lactam; and
   (iii) an aliphatic diacid comprising 6 to 22 carbon atoms and at least one aliphatic diamine with 2 to 14 carbon atoms,
   and, optionally,
b) at least one soft segment obtained by polycondensation of at least one diacid with 4 to 44 carbon atoms with at least one diamine chosen from diamines with 2 to 44 carbon atoms and polyoxyalkylene diamines,
   said copolyamide having a melting temperature Tm above 80° C. and a viscosity at 170° C., as measured using a Brookfield rheometer with SC 4-27 spindle, of between 2 Pa·s and 200 Pa·s.

Specifically, it has been found that these copolyamides have the properties required for the assembly of seamless textiles by printing, in particular by spraying droplets. The fact that it is a single-component hot-melt adhesive makes the process more flexible, since it is not necessary to respect the open time as with HMPUR adhesives.

Moreover, these copolyamides make it possible to be more friendly to health and the environment since they do not contain any residual solvents or isocyanates.

Finally, the copolyamides used according to the invention are recyclable because they are thermoplastic. Owing to the thermoplastic character of these polyamides, the textiles assembled by means thereof may be fully recyclable. In particular, when the textiles comprise or are also made of polyamide, the entire part can be ground and melted to provide a material capable of being used again. As indicated above, these copolyamides comprise at least one hard segment and optionally at least one soft segment. These two segments comprise one or more polyamide blocks. They may nevertheless also, where appropriate, include low contents of other monomers, for example polyether polyols chosen from polyethylene glycols (PEG), polypropylene glycols (PPG) and copolymers thereof, and polytetramethylene glycol (PTMG) for example, at a molar ratio of less than 20 mol%, preferably 10 mol% and in particular 5 mol%, relative to the segment. Advantageously, the hard and/or soft segments consist of polyamide blocks.

The hard segment of the copolyamide comprises or consists of one or more polyamide blocks. Polyamide blocks have carboxylic acid groups, amine groups or a mixture of both at the end.

The polyamide blocks forming the hard segment(s) of the copolyamide may be derived from the polycondensation of:
(i) at least one amino acid, and/or
(ii) at least one lactam, and/or
(iii) at least one diacid with at least one diamine.

The amino acid can in particular be an α,ω-aminocarboxylic acid, in particular comprising 4 to 12 carbon atoms. As such, mention may be made in particular of aminocaproic acid, 7-aminoheptanoic acid, 10-aminodecanoic acid, 11-aminoundecanoic acid and 12-aminododecanoic acid. Among these, 11-aminoundecanoic acid is particularly preferred.

The lactam can in particular be a lactam comprising 4 to 12 carbon atoms, in particular chosen from caprolactam, oenantholactam and lauryllactam.

The diacid (or dicarboxylic acid) can be aliphatic or cycloaliphatic. Preferably, it is a linear or branched aliphatic dicarboxylic acid comprising 4 to 44, preferably 6 to 36, and even more preferentially 6 to 18 carbon atoms or a cycloaliphatic dicarboxylic acid comprising 6 to 10 carbon atoms.

As examples of such dicarboxylic acids, mention may be made of (a) aliphatic dicarboxylic acids,notably with a straight, in particular saturated, chain, such as succinic acid, glutaric acid, adipic acid, pimelic acid, suberic acid, azelaic acid, sebacic acid, 1,11-undecanedioic acid, 1,12-dodecanedioic acid, brassylic acid, 1,14-tetradecanedioic acid, pentadecanedioic acid, thapsic acid and 1,18-octadecanedioic acid, but also of (b) cycloaliphatic acids such as 1,4-cyclohexyldicarboxylic acid and 1,2-cyclohexyldicarboxylic acid.

The diamine contains 2 to 14, in particular 4 to 12 and very particularly 6 to 12 carbon atoms. It can be an aliphatic, cycloaliphatic or aromatic diamine. Preferably, it is a straight or branched aliphatic diamine comprising 2 to 14, in particular 4 to 12 and very particularly 6 to 12 carbon atoms, or a cycloaliphatic diamine comprising 6 to 14 and in particular 6 to 12 carbon atoms.

As examples of diamines, mention may be made of 1,2-ethylenediamine, 1,4-tetramethylenediamine, 1,6-hexamethylenediamine, 1,9-nonamethylenediamine, 1,10-decamethylenediamine, 1,12-dodecamethylenediamine, trimethylhexamethylenediamine, the isomers of bis(3-methyl-4-aminocyclohexyl)methane (BMACM or B), p-aminodicyclohexylmethane (PACM or P), the isomers of 2,2-bis(3-methyl-4-aminocyclohexyl)propane (BMACP), 2,6-bis(aminomethyl)norbornane (BAMN), m-xylylenediamine (MXD), p-xylylenediamine (PXD) and piperazine (Pip).

Advantageously, the polyamide blocks of the hard segments derived from diamine.diacid pairs are chosen from: 26, 29, 210, 212, 214, 218, 412, 414, 418, 510, 512, 514, 610, 612, 614, 618, 912, 1010, 1012, 1014, 1018, Pip10, Pip12, Pip14, Pip16, Pip18, MXD6, PXD6, MXD10 and PXD10.

The polyamide blocks can result from the polymerization of a single monomer or of a mixture of two or more than two different monomers.

The polyamide blocks can be obtained in the presence of a dicarboxylic acid or of a diamine acting as a chain regulator, depending on whether polyamide blocks with carboxylic acid or amine ends are desired. If the precursors already comprise a dicarboxylic acid or a diamine, it is sufficient to use it in excess, but it is also possible to use another dicarboxylic acid or another diamine taken from the groups of dicarboxylic acids and of diamines defined below.

Preferably, the copolyamides comprise at least one hard segment obtained by polycondensation of caprolactam and 11-aminoundecanoic acid, lauryllactam, 1,6-hexamethylenediamine and adipic acid, 1,6-hexamethylenediamine and sebacic acid, 1,10-decamethylenediamine and sebacic acid, or 1,10-decamethylenediamine and 1,12-dodecanedioic acid, alone or in combination. Very particularly preferred are copolyamides comprising at least one hard segment obtained by polycondensation of caprolactam and 11-aminoundecanoic acid, of caprolactam and lauryllactam, or of caprolactam, 1,6-hexamethylenediamine and adipic acid.

The content of hard segments in the copolyamide can vary widely. Thus, the copolyamide may comprise from 1 to 100 mol%, advantageously from 10 to 90 mol%, in particular from 20 to 80 mol%, and even more preferentially from 30 to 70 mol% of hard segments. A content of 40 to 60 mol% of hard segments in the copolyamide is particularly preferred. The molar content of hard segments is determined by the molar ratio of the monomers introduced into the copolyamide.

The at least one optional soft segment of the copolyamide comprises or consists of one or more blocks obtained by polycondensation of at least one diacid with 4 to 44 carbon atoms and at least one diamine chosen from diamines with 2 to 44 carbon atoms and polyoxyalkylene diamines.

The at least one dicarboxylic acid may in particular be an aliphatic, cycloaliphatic or aromatic diacid or a fatty acid dimer.

Preferably, it is a linear or branched aliphatic dicarboxylic acid comprising 4 to 44, preferably 6 to 36, and even more preferentially 6 to 18 carbon atoms or a cycloaliphatic dicarboxylic acid comprising 6 to 10 carbon atoms.

The dicarboxylic acid may be chosen notably from (a) aliphatic dicarboxylic acids, notably with a straight, in particular saturated, chain, such as succinic acid, glutaric acid, adipic acid, pimelic acid, suberic acid, azelaic acid, sebacic acid, 1,11-undecanedioic acid, 1,12-dodecanedioic acid, brassylic acid, 1,14-tetradecanedioic acid, pentadecanedioic acid, thapsic acid and 1,18-octadecanedioic acid, (b) cycloaliphatic dicarboxylic acids such as 1,4-cyclohexyldicarboxylic acid and 1,2-cyclohexyldicarboxylic acid, (c) aromatic dicarboxylic acids such as terephtalic acid, isophthalic acid or naphthalenedicarboxylic acid, and (d) fatty acid dimers.

The fatty acid dimers can be obtained by dimerization of two identical or different fatty acids, comprising in particular 9 to 28, advantageously 12 to 24 and more especially 14 to 22 carbon atoms. They can be chosen in particular from oleic acid, linoleic acid, linolenic acid, palmitoleic acid, elaidic acid and erucic acid. The dimerization products of mixtures of unsaturated fatty acids can be obtained by the hydrolysis of vegetable oils or fats, for example sunflower oil, soybean oil, olive oil, rapeseed oil or cottonseed oil, or animal oils or fats, such as tallow. Fatty acid dimers that are hydrogenated, for example by using nickel catalysts, may also be used. The fatty acid dimer advantageously comprises on average 18 to 56, and preferably 36 or 44 carbon atoms. The fatty acid dimers preferably have a dimer content of at least 98%. Advantageously, they are hydrogenated.

Various acid dimers are marketed, for example under the brand PRIPOL® by the company Croda, under the brand EMPOL® by the company Cognis, under the trade name Unydime® sold by the company Kraton or else under the trade name Radiacid® sold by Oleon. These products generally contain from 75% to more than 98% of fatty acid dimers, as a mixture with the monomer, and other oligomers. These mixtures of fatty acid oligomers can furthermore be partially or completely hydrogenated.

The blocks obtained during the polycondensation of a diacid or of a fatty acid dimer with a polyoxyalkylene diamine are polyetheramide blocks. The blocks obtained during the polycondensation of a diacid or of a fatty acid dimer with a diamine are polyamide blocks.

The at least one diamine contains 2 to 44, in particular 4 to 36, more preferably 4 to 24 or 6 to 18 carbon atoms and very particularly 6 to 12 carbon atoms. It can notably be an aliphatic, cycloaliphatic or aromatic diamine. Preferably, it is a straight or branched aliphatic diamine comprising 2 to 44, in particular 4 to 36 and very particularly 6 to 12 carbon atoms, or a cycloaliphatic diamine comprising 6 to 18 and in particular 6 to 12 carbon atoms.

As examples of diamines, mention may be made of 1,2-ethylenediamine, 1,4-tetramethylenediamine, 1,6-hexamethylenediamine, 1,9-nonamethylenediamine, 1,10-decamethylenediamine, 1,12-dodecamethylenediamine, trimethylhexamethylenediamine, the isomers of bis(3-methyl-4-aminocyclohexyl)methane (BMACM or B), p-aminodicyclohexylmethane (PACM or P), the isomers of 2,2-bis(3-methyl-4-aminocyclohexyl)propane (BMACP), 2,6-bis(aminomethyl)norbornane (BAMN), m-xylylenediamine (MXD), p-xylylenediamine (PXD) and piperazine (Pip).

It is also possible to use fatty diamines, comprising up to 44, preferably 10 to 36, carbon atoms. They can be obtained in particular by reaction of fatty acids derived from oils or fats of plant or animal origin with ammonia and hydrogenation of the nitrile obtained. The fatty diamine can in particular originate from the amination of polymerized fatty acids, as defined above. These diamines are commercially available under the trade name “Versamine” sold by Cognis Corporation (BASF) and under the trade name Priamine® from Croda.

Advantageously, they are aliphatic diamines with a straight, in particular saturated, chain. Generally, they are primary amines, bearing the amine group in the terminal position.

The diamine can also be a polyetheramine, i.e. a polyoxyalkylene diamine. Preferably, it is a polyoxyalkylene chain bearing two chain-end amine groups. The polyoxyalkylene chain preferably comprises oxyethylene (POE), oxypropylene (POP) and oxytetramethylene (POTM) groups, alone or as a mixture. When the groups are mixed, POE and POP mixtures or else POTM and POP mixtures are preferred. In the field of polyamides, polyetheramines are usually denoted by an abbreviation specifying the nature of the oxyalkylene chain followed by a number indicating its number-average molecular weight (Mn). Thus, POP400 designates a polyetheramine comprising a polyoxypropylene chain having an Mn of 400 g/mol terminated by two amine groups. Polyoxyalkylene diamines can be obtained by cyanoacetylation of polyetherdiols. The polyoxyalkylene diamine is preferably chosen from commercially available products, in particular those sold by Huntsman under the Jeffamine® and Elastamine® brands (for example Jeffamine® D400, D2000, ED 2003 and XTJ 542 and Elastamine® RT 1000, RP 405 and RP 2009) or under the Baxxodur® brand by the company BASF (for example Baxxodur® EC 302, EC 301, EC 303 and EC 311).

The number-average molecular weight (Mn) of the polyoxyalkylene diamine is preferably between 60 and 2000 g/mol, in particular between 80 and 1500 g/mol, and notably between 100 and 500 g/mol. Preferably, the soft segments are obtained by polycondensation of a polyoxyalkylene diamine based on polyoxypropylene (POP), in particular with a number-average molecular weight (Mn) of between 60 and 2000 g/mol, with an aliphatic diacid comprising 6 to 36 carbon atoms, in particular adipic acid, or a dimerized fatty acid comprising 36 to 44 carbon atoms.

Advantageously, the polyamide blocks of the soft segments are obtained by polycondensation of adipic acid, sebacic acid, dodecanedioic acid or a fatty acid dimer with a polyoxyalkylene diamine, in particular a polyoxypropylene diamine (POP), the polyoxypropylene chain of which has a number-average molecular weight Mn from 100 to 2000 g/mol, in particular from 200 to 100 g/mol and in particular of 400 g/mol (POP400).

The content of soft segments in the copolyamide can vary widely. Thus, the copolyamide used according to the invention comprises 0 to 99 mol%, advantageously 5 to 90 mol%, in particular 20 to 80 mol%, and more preferably 30 to 70 mol% of soft segments. A content of 40 to 60 mol% of soft segments in the copolyamide is particularly preferred. The molar content of soft segments in the copolyamide is determined as explained above for the hard segments.

It has been found that particularly advantageous properties can be obtained when at least 20 mol%, in particular at least 30 mol% and very particularly at least 40 mol% of the monomers of the copolyamides used comprise at least 8, and preferably at least 9, carbon atoms. As an exception to the general definition of the term monomer above, diamines and diacids are also considered to be monomers in this context.

Particularly preferred for the use according to the invention are the copolyamides chosen from PA 6/11/POP40036, PA 6/11/POP4006, PA 11/POP4006, PA 11/POP40010, PA 6/12/POP40036, PA 6/12/POP4006, PA 12/POP4006 and PA 12/POP40010, PA 6/66/11/12/POP4006, PA 6/612/12/POP40012 and PA 6/66/11/12/POP4006.

Alternatively, a copolyamide chosen from 6/610, 106/1012, 6/66/11/12, 6/612/12 and 6/66/11/12 is also preferred.

The copolyamides used according to the invention can be manufactured according to the usual processes described in the prior art. Reference may be made in particular to the process described in patent application EP 1 533 330 A1. In this method, all the reagents are introduced in one go into a suitable reactor, optionally adding an acid such as phosphorous acid. The combined mixture is heated under nitrogen at a typical temperature of 235° C. for a typical time of 60 min in order to then put the reactor under vacuum and continue the reaction for a typical time of 30 min. Of course, the temperatures and times can be varied to take account of the reactivity of the chosen reagents.

The copolyamides can be obtained in the presence of a dicarboxylic acid or of a diamine acting as a chain regulator, depending on whether carboxylic acid or amine ends are desired. If the precursors already comprise a dicarboxylic acid or a diamine, it is sufficient to use it in excess, but it is also possible to use another dicarboxylic acid or another diamine taken from the groups of dicarboxylic acids and of diamines defined below.

The viscosity of the copolyamide is a parameter which assumes particular importance in application by means of the printing process, in particular by spraying droplets or by 3D printing. Specifically, when the viscosity is too high, the copolyamide does not pass, or passes with difficulty, through the spray nozzle or the extrusion head and printing is difficult or even impossible. Conversely, when the viscosity is too low, the copolyamide penetrates into the textile too much. Only very little adhesive is then left between the substrates to be bonded, which results in poor adhesion.

It has been observed that a copolyamide having a viscosity, as measured at 170° C. using a Brookfield rheometer with the SC 4-27 spindle, according to standard ASTM D3236-88 of 2009, of between 2 and 200 Pa·s, preferably between 5 and 100 and in particular between 8 and 60 Pa·s and very particularly between 10 and 40 Pa·s at 170° C. gives very satisfactory results in printing.

According to the invention, the copolyamide has a melting temperature (Tm) above 80° C. Preferably, the copolyamide has a melting temperature (Tm) below 210° C. Such a melting temperature allows it to be used on many substrates. Advantageously, the melting temperature (Tm) of the copolyamide is between 85° C. and 200° C., preferably between 87° C. and 180° C., in particular between 90° C. and 170° C., more preferably between 92° C. and 160° C., in particular between 95° C. and 150° C. and very particularly between 100° C. and 140° C.

As mentioned above, a sufficiently low glass transition temperature makes it possible to ensure good flexibility of the textile and acts in favor of a reduced viscosity, which, as explained above, facilitates printing. Preferably, the copolyamide has a glass transition temperature (Tg) below 60° C., advantageously, the Tg of the copolyamide is between -80° C. and 60° C., preferably between -75° C. and 50° C., in particular between -70° C. and 40° C., and more preferably between -65° C. and 35° C.

Owing to the advantages discussed above, and good adhesion to the substrates, the use of a copolyamide described makes it possible to obtain seamless textile assemblies by printing with a high adhesion strength, that is more than enough to withstand prolonged use.

According to a second aspect, the invention relates to a process for manufacturing articles by seamless textile assembly by printing, wherein the textile substrates are assembled by means of a copolyamide as described above. Advantageously, the process is automated and does not require labor.

The textiles to be assembled for the manufacture of the article can be of various types, and in particular include or consist of natural materials such as cotton, wool, linen, hemp, jute, raffia, ramie, rattan, sisal, wood, abaca, coconut, bamboo, kenaf, silk, alpaca, angora, camel hair, cashmere, llama, mohair, vicuna, yak or mixtures thereof, and materials derived from natural materials such as viscose, Lyocell® or modal. They may also be textiles comprising or consisting of thermoplastic polymers such as a polyester, polypropylene, polyacrylate, polyamide, thermoplastic polyurethane elastomer (Lycra® or elastane), PTFE, PVDF, polybutylene, polyisoprene, aramid (Kevlar®), polybenzimidazole (PBI), a polyethylene in particular of ultra-high weight, a liquid crystal polymer or else microfibers. The textiles may also comprise or consist of fibers of inorganic materials, such as carbon, glass, copper, aluminum, or steel. The shoe materials may furthermore comprise or consist of a textile as described above, where appropriate coated with a polymer such as polyurethane, or leather, polyether, polyamide or elastomer such as PEBA or TPUs.

Preferably, the textile substrates used comprise a polyamide. Specifically, the copolyamides described exhibit a particularly high adhesion of the copolyamide to this substrate. Advantageously, the textile substrates comprise at least 60%, in particular at least 70%, more preferably at least 80%, in particular at least 90% by weight of polyamide or else are composed of polyamide. Depending on the desired properties, the substrate may however also comprise other materials, in particular other polymers. Advantageously, these are thermoplastic polymers. The substrate may thus comprisenotably an elastomer, in particular a thermoplastic polyurethane elastomer such as elastane.

The use of thermoplastic textile substrates based on thermoplastic materials makes it possible to envisage complete recycling. More specifically, the textile can be ground and then melted to give a material which can be used again, in particular for the manufacture of textiles. It may also be interesting to recycle textiles, a minor portion of which is not thermoplastic.

The process is particularly advantageous for the manufacture of articles of clothing, in particular underwear, sportswear and also protective clothing. Furthermore, it may be advantageous for the manufacture of shoes, in particular sports shoes, containers, for example bags or baskets, furniture, blinds, leisure equipment such as backpacks and tents or else sporting goods such as balloons, kites, sails and parachutes.

In general, the copolyamide according to the invention is printed directly on the substrate(s) to be assembled. It is advantageously printed in the solid state or in the melt state. Advantageously, it is printed in the form of dots. The dots can be printed so as to form a more or less complex pattern. The copolyamide can be printed on the substrate by various means.

For example, it is possible to use the “jetting” printing technique, in which droplets of molten copolyamide are sprayed at high speed from a dispenser onto the substrate by means of a short high-pressure pulse. This technique, used in particular in the devices sold by the company Nordson, makes it possible to avoid contact between the substrate and the nozzle and is described for example in applications WO 2011/087961 A1 and WO 2011/153422 A1.

Other suitable devices use extrusion to print the copolyamide onto the substrate. The hot-melt adhesive can in particular be applied to the substrate by extrusion, for example using the device sold by the company Arburg under the name Freeformer, which makes it possible to melt granules like in injection molding and to apply them in the form of droplets.

It is also possible to print the copolyamide on the substrate in the form of filament, for example by means of the fused filament deposition technique (Fused Deposition Modeling (FDM) also referred to as Fused Filament Fabrication (FFF)). Devices suitable for carrying out this technique are for example sold by Stratasys, 3D Systems and devices to be assembled are sold under the name Reprap 3D printer. This technique has the advantage of avoiding the heating of the copolyamide for long periods, which limits the degradation thereof. In these extrusion techniques, the print head is generally in contact with the substrate.

According to a third and final aspect, the invention relates to an article capable of being obtained by the process described above. These articles have the advantage of being able to be assembled by an automated process and of being recyclable, in particular when the textile substrate is at least partially thermoplastic.

These articles may be clothing, notably underwear, sportswear and also protective clothing. Furthermore, they may be shoes, in particular sports shoes, containers, for example bags or baskets, furniture, blinds, leisure equipment such as backpacks and tents or else sporting goods such as balloons, kites, sails and parachutes.

The invention will be explained in greater detail in the examples that follow.

### EXAMPLES

### Examples 1 to 7 - Synthesis of Copolyamides

In order to evaluate various copolyamides in the intended application, a series of copolyamides composed of hard segments and optionally of soft segments was synthesized. In these copolyamides, the hard segments are formed from aliphatic polyamide units resulting from the polycondensation of caprolactam and 11-aminoundecanoic acid (6/11) or 11-aminoundecanoic acid alone (11) or else caprolactam, adipic acid/hexamethylenediamine, 11-aminoundecanoic acid and lauryllactam (6/66/11/12) and the soft segments are formed from polyamide units obtained by polycondensation of a polyoxyalkylene diamine with an aliphatic dicarboxylic acid such as Jeff4006 or Jeff40036.

The specific components and proportions used for the synthesis of each copolyamide are indicated in table 1 below. The amount of each component is expressed as a weight percentage relative to all of the reagents used.
Diamines:
   Polyetherdiamine: Polyoxypropylene diamine, the alkoxy chain of which has an average molecular weight Mn of 400 g/mol (Baxxodur EC 302 sold by BASF)
Diacids:
   Monofunctional fatty acid: C16/C18 saturated fatty acids (Radiacid 0944)
   Fatty acid dimer 1: Distilled hydrogenated diacid with an average of 36 carbon atoms (Pripol 1009 sold by Croda)
   Fatty acid dimer 2: Distilled diacid comprising on average 36 carbon atoms (Pripol 1013 sold by Croda)

TABLE 1

Reagents for synthesis of the copolyamides studied

| Reagents | RefA | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Caprolactam | - | 15.9 | 25.3 | 21.9 | 24.8 | - | - | 39.1 | 14.5 |
| 11-Aminoundecanoi c acid | - | 32.0 | 22.4 | 16.5 | 22.1 | 40.2 | 34.6 | 20.1 | 24.3 |
| Lauryl lactam | - | - | - | - | - | - | - | - | 34 |
| Stearic acid | - | - | - | - | - | - | - | - | 3.1 |
| EDA | 10 | - | - | - | - | - | - | - | - |
| HMDA | 1 | - | - | - | - | - | - | - | 12 |
| Polyetherdiamin e | - | 21.3 | 21.0 | 25.3 | 20.6 | 43.3 | 48.4 | 29.8 | - |
| Monofunctional fatty acid | 10 | - | - | - | - | - | - | - | - |
| Diacid of dimer 1 | - | 30.8 | 31.3 | - | - | - | - | - | - |
| Diacid of dimer 2 | 79 | - | - | 36.3 | 32.5 | - | - | - | - |
| Adipic acid | - | - | - | - | - | 16.4 | 16.9 | 10.9 | 12.1 |
| H₃PO₂ | - | - | - | - | - | 0.1 | 0.1 | 0.1 | - |
| Total | 100 | 100 | 100 | 100 | 100 | 100 | 100 | 100 | 100 |
| Copolyamide | PA 236/ 636 | PA 6/11/ POP 40036 | PA 6/11/ POP 40036 | PA 6/11/ POP 40036 | PA 6/11/ POP 40036 | PA 11/ POP40 06 | PA 11/ POP 4006 | PA 6/11/ POP40 06 | PA 6/66/1 1/12 |

### Evaluation of the Copolyamides

The copolyamides synthesized were evaluated with respect to their adhesion properties on a reference textile for the manufacture of bras. This textile is composed of 78% polyamide and 22% elastane and has a weight of 160 gsm (g/m2).

The melting temperatures and viscosities at 170° C. of the exemplified copolyamides are collated in table 2 below.

The adhesion properties of the synthesized copolyamides on the textile were evaluated as follows. On a strip of textile as described above, each copolyamide was printed in a pattern composed of dots with a diameter of around 1 mm (around 0.25 mg per dot, diameter after heat sealing around 1.5 mm) arranged in 10 columns spaced 24 mm apart and 5 rows spaced 12.5 mm apart using a Nordson Unity 5 Jetting dispenser equipped with a 30 ml cartridge at an appropriate printing temperature and with the following parameters:
Print speed: 110 mm/s
Air pressure: 40 PSI
Gun on / Gun off: 10 ms / 10 ms
Nozzle diameter: 0.007 inch
Print height: 20 mm

The textile strip coated with printed polyamide dots was superimposed and then heat-sealed onto a second strip of the same textile at various temperatures, for 20 s at a pressure of 0.6 MPa using a platen press.

The adhesion strength of the bond thus produced was then evaluated by means of the following peel test.

The peel tests were carried out at 23° C. by measuring the force needed to separate the textile strips, the pull force being exerted on one of them at a peel angle of 180° at a speed of 200 mm/min using an MTS Systems SANS CMT5504 universal testing machine.

The peel test was repeated after having subjected the samples to 10 wash cycles at 40° C. (“cotton” programme), with 45 ml of Tide brand detergent followed by a drying cycle in a BOSCH XQG80-WDG244601W machine. From the peel strength measured on the washed samples, the percentage loss of peel strength after washing is calculated.

The results of the evaluation are recorded in table 2 below.

TABLE 2

Application properties of the copolyamides

| Example | Tm [°C] | Viscosity at 170° C. [Pa.s] | T_{printing} [°C] | Tₚᵣₑₛₛ [°C] | Peel strength [N/12.5 mm] | Loss after washing [%] |
|---|---|---|---|---|---|---|
| Ref. A | 106 | 2 | 140° C. | 130 | 3 | -17.2 |
| 1 | 102 | 9 | 175° C. | 120 | 10.5 | -11.3 |
| 2 | 112 | 8 | 170° C. | 90 | 12.1 | -6.5 |
| 3 | 108 | 10 | 170° C. | 110 | 9.5 | N.D. |
| 4 | 119 | 3.5 | 140° C. | 120 | 9.5 | -2.5 |
| 5 | 133 | 4.3 | 160° C. | 152 | 8.5 | -13.5 |
| 6 | 118 | 5 | 160° C. | 140 | 7.1 | -6.5 |
| 7 | 122 | 5.5 | 170° C. | 100 | 9.4 | 38.9 |
| 8 | 99 | 53 | 180° C. | 150 | 21 | 0.0 |

All the results show that the adhesion obtained by means of the printed copolyamides is of better quality when the viscosity of the polyamide, at the temperature chosen for the application, is appropriate. Specifically, when the viscosity is too high, it is difficult to print precise patterns and therefore to minimize the amount of glue per part. Conversely, when the viscosity is too low, the polyamide penetrates and diffuses into the textile, which thereby weakens the adhesion.

The results of the evaluation of the peel strength of the adhesions using the polyamides of examples 1 to 8 are significantly better than that measured for the reference product, which comprises only soft segments.

The results furthermore show that the quality of the adhesion is not affected by washing in a washing machine and withstands both hot water and detergents. The polyamides tested therefore retain their good adhesion after the washing/drying cycles.

### List of Documents Cited

WO 2011/153422 A1
WO 2011/087961 A1

1. The use, for seamless textile assembly by printing, of a copolyamide comprising:
a) at least one hard segment obtained by polycondensation of at least one of the following:
(i) an α,ω-aminocarboxylic acid;
(ii) a lactam; and
(iii) an aliphatic diacid with 6 to 22 carbon atoms and at least one aliphatic diamine with 2 to 14 carbon atoms,
and, optionally,
b) at least one soft segment obtained by polycondensation of at least one diacid with 4 to 44 carbon atoms with at least one diamine chosen from diamines with 2 to 44 carbon atoms and polyoxyalkylene diamines,
said copolyamide having a melting temperature Tm above 80° C. and below 210° C. and a viscosity at 170° C., as measured according to standard ASTM D3236-88 (2009), using a Brookfield rheometer with SC 4-27 spindle, of between 5 Pa·s and 100 Pa·s.

2. The use as claimed in claim 1, in which the copolyamide comprises hard segments obtained by polycondensation of caprolactam, lactam 12, 11-aminoundecanoic acid, 1,6-hexamethylenediamine and sebacic acid, 1,10-decamethylenediamine and sebacic acid, 1,10-decamethylenediamine and 1,12-dodecanedioic acid, or a mixture thereof.

3. The use as claimed in claim 1, wherein the copolyamide comprises hard segments obtained by polycondensation of caprolactam, 1,6-hexamethylenediamine and adipic acid, or a mixture thereof.

4. The use as claimed in claim 1, wherein the copolyamide comprises soft segments obtained by polycondensation of a polyoxyalkylene diamine having a molecular weight of between 60 and 2000 g/mol and of an aliphatic diacid comprising 6 to 36 carbon atoms.

5. The use as claimed in claim 1, wherein the copolyamide is chosen from the group consisting of PA 6/11/POP40036, PA 6/11/POP4006, PA 11/POP4006, PA 11/POP40010, PA 6/12/POP40036, PA 6/12/POP4006, PA 12/POP4006 and PA 12/POP40010, PA 6/66/11/12/POP4006, PA 6/612/12/POP40012, PA 6/66/11/12/POP4006, PA 6/11/3636 and PA 11/3636.

6. The use as claimed in claim 1, wherein the copolyamide is chosen from PA 6/11/12, PA 6/612/12, PA 6/1012/12 and PA 6/66/11/12.

7. The use as claimed in claim 1, wherein the copolyamide has a viscosity, at 170° C., as measured according to standard ASTM D3236-88 (2009), using a Brookfield rheometer with SC 4-27 spindle, of between 8 Pa·s and 60 Pa·s.

8. The use as claimed in claim 1, wherein the copolyamide has a melting temperature (Tm) of between 85° C. and 200° C.

9. The use as claimed in claim 1, wherein the copolyamide has a glass transition temperature (Tg) below 60° C.

10. The use as claimed in claim 1, wherein the copolyamide makes it possible to achieve a peel strength, measured according to the test described in the examples, of at least 8 N/12.5 mm, at 23° C.

11. A process for manufacturing articles by seamless assembly by printing, wherein the textile substrates are assembled by means of a copolyamide as defined in claim 1.

12. The process as claimed in claim 11, wherein the textile substrates comprise a polyamide.

13. An article capable of being obtained by the process as claimed in claim 11.

14. The article as claimed in claim 13, wherein the article is a garment or a shoe.
